(19) United States
(12) Patent Application Publication
(10) Pub. No.: US 2009/0096851 A1
(43) Pub. Date: Apr. 16, 2009

(54) INK CARTRIDGE FOR AN INKJET PRINTER

(75) Inventor: Daniel Sulser, Wald (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Pelikan Hardcopy Production AG, Egg (CH)

(21) Appl. No.: 12/249,039

(22) Filed: Oct. 10, 2008

(30) Foreign Application Priority Data
Oct. 10, 2007 (DE) 102007048820.5

(51) Int. Cl. B41J 2/175

(52) U.S. Cl. 347/86

(57) ABSTRACT

Ink cartridge (10) for an inkjet printer, having a housing (11) which bounds at least one ink chamber (12) and on the bottom side, or base (14), of which there is formed a connection port (15) for establishing a fluid connection between the ink chamber (12) and a supply connection provided at the inkjet printer. With the connection port (15) there is associated, especially arranged upstream thereof, an ink supply channel (17) extending over a predetermined height of the connection port, which channel is formed in the base (14) of the ink cartridge (10).

### CROSS-REFERENCE TO RELATED APPLICATIONS

This application claims the benefit of DE 10 2007 048 820.5, filed Oct. 10, 2007, which is incorporated by reference as if fully set forth.

### BACKGROUND

The invention relates to an ink cartridge for an inkjet printer. Ink cartridges of such a kind are generally known. In that regard reference is made, solely by way of example, to EP 1 481 809 A2, EP 1 550 558 A1, EP 1 547 783 A2 or EP 0 879 703 A2.

It is common to all those ink cartridges that they are insertable in a cartridge receptacle of an inkjet printer. For a functionally reliable ink supply it is necessary for the ink cartridge to have an element which produces a negative pressure and retains the ink sufficiently so that the ink cartridge does not run out when not being used. On the other hand, when the printer is being used, the ink must continue to flow to a sufficient extent so that the print head is supplied with ink during operation. The element that produces negative pressure usually consists of a sponge or fibrous material, which is arranged inside a so-called ink storage chamber immediately before an outlet port to the supply connection of the inkjet printer.

Various methods are known for the filling of an ink cartridge of such a kind, for example filling under vacuum or forced filling using raised pressure. With all those filling methods it is unavoidable that relatively small amounts of air in the form of bubbles remain behind in the cartridge. If this occurs in the region of the ink supply close to the ink off-take aperture or connection port for establishing a fluid connection between the ink storage chamber and a supply connection provided at the inkjet printer, it can reduce the print quality or even result in complete failure.

It has previously been attempted to solve this problem using a multiplicity of grooves towards the ink off-take aperture or using long flat channels. However, once the bubbles become a certain size, those measures usually have no effect, which is the point from which the present invention starts.

### SUMMARY

The object of the present invention is accordingly to provide an ink cartridge of the kind mentioned at the beginning which is constructed so that the supply of ink is not interrupted by various sizes of bubbles formed in the course of filling the ink cartridge, more particularly also when relatively large bubbles are formed.

This objective is met with the inkjet cartridge according to the present invention, with preferred embodiments and constructional details being described below.

According to the invention, an ink supply channel is formed in the base of the cartridge, which channel extends preferably over at least half to three-quarters of the length of the base and is downwardly inclined in the direction of the connection port, or ink off-take aperture. This makes it possible for flow to take place without any problems beneath bubbles that are formed there, so that the ink flow towards the connection port, or ink off-take aperture, is maintained. In this context it should be mentioned that the ink supply channel preferably remains in fluid connection with the ink storage chamber over its entire length, that is to say it is open at its top side. If an ink storage element in the form of a sponge or fibre element is present in the ink storage chamber, that element is immediately adjacent to the open top side of the ink supply channel. Any air bubbles then collect at the top of the ink supply channel, or bottom of the ink storage element. Beneath those bubbles, the ink supply to the connection port, or ink off-take aperture, is maintained.

In a further preferred embodiment, the cross-section of the ink supply channel has a ratio of width to depth of less than 1, and the value of this ratio decreases in the direction of the ink off-take aperture. The width of the ink supply channel at its top is preferably constant and is 1.0 to 3.0 mm, with the width decreasing in the depth direction. Preference is given to the cross-section of the ink supply channel being approximately V-shaped.

In this manner it is ensured that air bubbles of whatever size cannot interrupt the ink supply, because there is always sufficient cross-sectional space still available for the ink supply beneath such bubbles.

As a result of the fact that the ink supply channel is so constructed that, in use of the ink cartridge, the ink located in the ink supply channel flows to the connection port or ink off-take aperture, under gravity, ensuring almost complete emptying of the ink cartridge, especially also a re-filled ink cartridge. In a specific embodiment, this feature is realised by the fact that the bottom of the ink supply channel is downwardly inclined in the direction of the connection port, or ink off-take aperture.

At the bottom of the ink supply channel, the width is preferably between approximately 0.1 and 2.0 mm, that width decreasing, especially decreasing continuously, as the depth of the ink supply channel increases. In the case of an ink supply channel having a V-shaped cross-section, the above-mentioned feature is necessarily achieved if the angle between the two side walls of the ink supply channel remains constant over the length but the bottom of the ink supply channel is downwardly inclined in the direction of the connection port, or ink off-take aperture.

### BRIEF DESCRIPTION OF THE DRAWINGS

An exemplary embodiment of an ink cartridge constructed in accordance with the invention will be explained hereinbelow with reference to the accompanying drawings, in which:

FIG. 1 is a perspective view, at an angle from below, of an ink cartridge constructed in accordance with the invention;

FIG. 2 shows the ink cartridge according to FIG. 1 in longitudinal section;

FIG. 3 is a side view of the ink cartridge according to FIG. 1;

FIG. 4 shows the ink cartridge according to FIG. 3 in a section along line A-A; and

FIG. 5 shows the ink cartridge according to FIG. 3 in a section along line B-B.

### DETAILED DESCRIPTION OF THE PREFERRED EMBODIMENTS

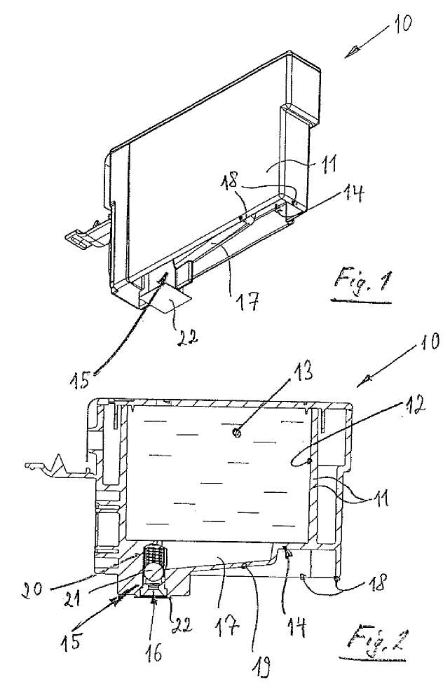

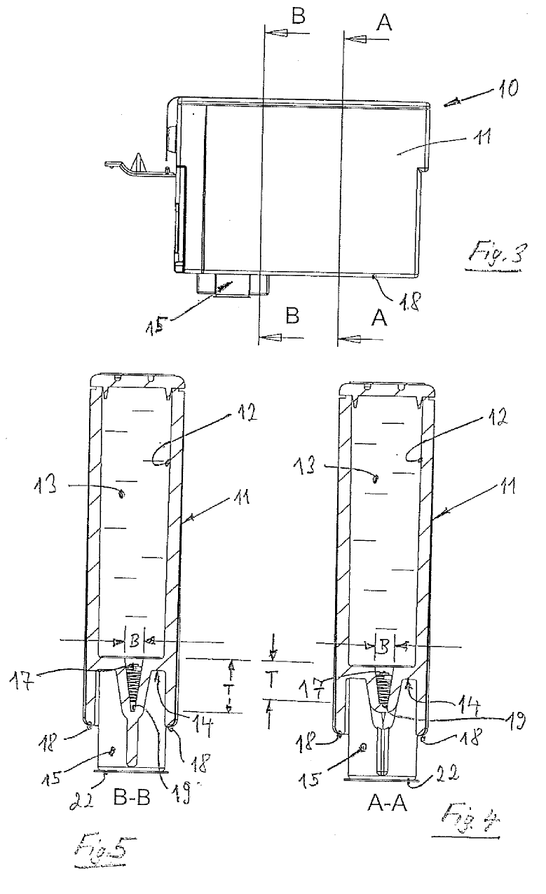

FIGS. 1 to 5 show an ink cartridge 10 in various views and sections. This ink cartridge has a housing 11 made of plastic material, which bounds an ink storage chamber 12, an ink storage element of sponge material or fibrous material being located in the ink storage chamber 12. In the region of that ink storage element, on the underside of the cartridge or in the base 14 thereof, there is located a connection port 15, which bounds an ink off-take aperture 16, by way of which a fluid connection can be established between the ink storage chamber 12 and a supply connection provided at the inkjet printer. The cartridge 10 can also be constructed having two chambers divided by a partition wall, in which case the chambers are in fluid connection with one another by a through-hole formed in the bottom end of the partition wall. In one chamber there is located a storage element made from sponge or fibres, corresponding to the ink storage element 13, whereas the other chamber is filled with ink. In this embodiment too, the connection port is associated with the chamber having the ink storage element. Because this is an arrangement known per se, no further description is required in this regard.

Of particular importance to the embodiment shown is the fact that with the connection port 15 there is associated, especially arranged upstream thereof, an ink supply channel 17 which extends over a predetermined height of the connection port, in this case approximately over half the height thereof, and which is formed in the base 14 of the ink cartridge 10. This ink supply channel 17 is a recessed arrangement relative to the bottom peripheral edge 18 of the end and side walls bounding the housing 11 of the ink cartridge, as can be seen very well, especially from FIGS. 2, 4 and 5.

As FIGS. 1 and 2 furthermore show, the ink supply channel 17 extends over approximately half the length of the base. It can furthermore be seen very well from FIG. 2 that the ink supply channel 17 is so constructed that, in use of the ink cartridge, that is to say in a position in which the base 14 is located at the bottom, the ink located in the ink supply channel 17 flows to the connection port 15, or ink off-take aperture 16, under gravity. Specifically, the bottom 19 of the ink supply channel 17 is downwardly inclined in the direction of the connection port 15, or ink off-take aperture 16.

As already mentioned hereinbefore and as can be seen especially from FIGS. 4 and 5, the cross-section of the ink supply channel 17 has a ratio of width “B” to depth “T” of less than 1 (B:T<1), with this ratio decreasing in the direction of the connection port 15, or ink off-take aperture 16. With a constant width “B” at the top of the ink supply channel 17 this means that the latter becomes deeper in the direction of the connection port 15, or ink off-take aperture 16.

In accordance with FIGS. 4 and 5, the cross-section of the ink supply channel 17 reduces from top to bottom, that is to say in the direction of the bottom 19 of the channel, and more particularly is approximately V-shaped. At the top of the ink supply channel 17, the width “B” is approximately constant over the length and is approximately 1.0 to 3.0 mm. At the bottom 19 of the ink supply channel 17, the width thereof is approximately 0.1 to 2.0 mm, and especially approximately 0.3 to 2.0 mm, with the width decreasing, especially decreasing continuously, as the depth “T” of the ink supply channel 17 increases.

In the embodiment shown, a valve ball 21 resiliently biased by a helical compression spring 20 is associated with the ink off-take aperture 16, as a result of which the ink off-take aperture 16 is kept closed when the cartridge is not being used. Only in use is the valve ball 21 lifted away from the ink off-take aperture 16 by means of a plunger-like supply connection of the inkjet printer, so that the desired fluid connection, or ink connection, is established between the cartridge and inkjet printer.

Prior to first use, the ink off-take aperture 16 is also still additionally sealed on the outside by a film 22, which is punctured before first use so that the ink off-take aperture is accessible from the outside. This too is a feature already known per se. The features of the present invention disclosed in the application can be used on their own or in combination, and the invention is not limited to the preferred embodiment discussed above.

Reference Numerals:

10 ink cartridge

11 housing

12 ink storage chamber

13 ink storage element

14 base

15 connection port

16 ink removal opening

17 ink supply channel

18 bottom peripheral edge of housing

19 bottom of ink supply channel

20 compression spring (resilient element)

21 valve ball

22 sealing film

1. Ink cartridge (10) for an inkjet printer, comprising a housing (11) which bounds at least one ink chamber (12) and on a bottom side, or base (14), of which there is formed an ink off-take aperture (16) or a connection port including said aperture, an ink supply channel (17) extending over a predetermined height of the connection port, the ink supply channel is formed in the base (14) of the ink cartridge (10) upstream of the ink off-take aperture or the connection port including said aperture for establishing a fluid connection between the ink chamber (12) and a supply connection provided at the inkjet printer via the ink off-take aperture (16) or the connection port (15) including said aperture.

2. Ink cartridge according to claim 1, wherein the ink supply channel (17) extends over at least half to three-quarters of a length of the base.

3. Ink cartridge according to claim 1, wherein the ink supply channel (17) is constructed so that, in use of the ink cartridge, the ink located in the ink supply channel (17) flows to the connection port (15) or ink off-take aperture (16), due to gravity.

4. Ink cartridge according to claim 3, wherein a bottom (19) of the ink supply channel (17) is downwardly inclined in a direction of the connection port (15) or ink off-take aperture (16).

5. Ink cartridge according to claim 1, wherein a cross-section of the ink supply channel (17) has a ratio of width (B) to depth (T) of less than 1, and the ratio decreases in a direction of the connection port (15) or ink off-take aperture (16).

6. Ink cartridge according to claim 1, wherein a cross-section of the ink supply channel (17) reduces from top to bottom.

7. Ink cartridge according to claim 6, wherein the cross-section of the ink supply channel (17) is approximately V-shaped.

8. Ink cartridge according to claim 6, wherein a width (B) at the top of the ink supply channel (17), over which width the channel is in communication with the ink chamber (12), is constant over a length of the channel and is approximately 1.0 to 3.0 mm.

8. Ink cartridge according to claim 6, wherein a width (B) of the ink supply channel (17) at the bottom (19) thereof is between approximately 0.1 mm and 2.00 mm, and the width decreases as a depth (T) of the ink supply channel (17) increases.
